(19) United States
(12) Patent Application Publication
(10) Pub. No.: US 2013/0020730 A1
(43) Pub. Date: Jan. 24, 2013

(54) Wet Flue Gas Desulfurization Device

(71) Applicants: Takashi Muramoto, Kure-shi (JP); Shogo Mori, Kure-shi (JP); Hiroyuki Nosaka, Kure-shi (JP); Takanori Nakamoto, Kure-shi (JP)

(72) Inventors: Takashi Muramoto, Kure-shi (JP); Shogo Mori, Kure-shi (JP); Hiroyuki Nosaka, Kure-shi (JP); Takanori Nakamoto, Kure-shi (JP)

(73) Assignee: Babcock-Hitachi Kabushiki Kaisha, Tokyo (JP)

(21) Appl. No.: 13/639,707

(22) PCT Filed: Apr. 7, 2011
(86) PCT No.: PCT/JP2011/058806

§ 371 Date: Oct. 5, 2012

(30) Foreign Application Priority Data
Apr. 7, 2010 (JP) 2010-088893

(51) Int. Cl. B01D 53/18

(52) U.S. Cl. 261/116

(57) ABSTRACT

A wet flue gas desulfurization device includes, an absorber provided with: a absorber tank provided at a lower part of the absorber so as to store an absorption liquid; an absorption portion provided above the absorber tank and having multiple stages of spray headers for spraying the absorption liquid; an absorption liquid circulation system for circulating the absorption liquid in the absorber tank to the spray headers; an exhaust gas inlet portion provided in a sidewall between the absorber tank and the absorption portion; and a gas blow-out prevention member provided along an entire circumference of an inner surface of the sidewall between the exhaust gas inlet portion and the uppermost-stage spray header. Dams are intermittently provided at an inner peripheral end of the gas blow-out prevention member to extend along a circumferential direction thereof.

### TECHNICAL FIELD

The present invention relates to a flue gas treatment device for purifying flue gas of fuel discharged from a combustion device such as a boiler installed in a thermal power plant, a factory, etc. Particularly, it relates to a wet flue gas desulfurization device for reducing acidic gas such as sulfur oxide, hydrogen chloride, hydrogen fluoride, etc. or dust and soot contained in flue gas, and substances such as minor components contained in fuel.

### BACKGROUND ART

FIG. 22 shows a general system of a wet flue gas desulfurization device in a thermal power plant.

In FIG. 22, exhaust gas 1 discharged from a boiler or the like installed in a thermal power plant, a factory or the like is introduced into an absorber 4 from a gas inlet portion 3. The absorber 4 is chiefly constituted by an absorber tank 5 located in a lower part of the absorber and an absorption portion 6 located in an upper part of the absorber. The opening of a slurry flow rate control valve 16 is adjusted so that a proper amount of an absorption liquid S consisting of limestone slurry can be supplied to the absorber tank 5 in accordance with the content of sulfur oxide in the exhaust gas 1 from the boiler or the like.

The slurry-like absorption liquid S in the absorber tank 5 is boosted in pressure by an absorber circulation pump 10, and supplied through an absorber circulation pipe 13 to spray headers 8 which are provided in multiple stages (at least three stages) in an upper empty tower part inside the absorber 4 to extend along the gas flow direction. A large number of spray nozzles 9 are provided and arrayed in each spray header 8. Due to gas-liquid contact between the absorption liquid S sprayed from the spray nozzles 9 and the exhaust gas 1, acidic gas contained in the exhaust gas, such as sulfur oxide, hydrogen chloride, hydrogen fluoride, etc., is absorbed in the surfaces of droplets of the absorption liquid S.

After that, mist accompanied by the exhaust gas is eliminated by a mist eliminator 7 placed in an outlet of the absorber 4. Clean exhaust gas 2 running through an absorber outlet flue is heated again if necessary, and then discharged from a chimney.

Sulfur oxide in the exhaust gas 1 reacts with a calcium compound in the absorption liquid S. Thus, calcium sulfite is formed as an intermediate product. The calcium sulfite flowing down into the absorber tank 5 of the absorber 4 is oxidized by the air supplied into the absorption liquid S in the absorber tank 5 by an oxidation air blower 17. Thus, gypsum is formed as a final product.

The oxidation air supplied to the absorber 4 at that time is dispersed finely by an oxidation agitator 15 for agitating the absorption liquid S in the absorber tank 5. Thus, the utilization ratio of the oxidation air is enhanced. After that, the absorption liquid S is sent out from the absorber tank 5 to gypsum dewatering equipment 12 by an bleed pump 11 in accordance with the amount of the produced gypsum. Thus, the absorption liquid S is dewatered and recovered as gypsum 14.

In the background-art wet flue gas desulfurization device, a part of droplets of the absorption liquid S sprayed from the spray nozzles 9 placed in the spray headers 8 flow down along a sidewall of the absorber 4 and fall into the absorber tank 5. The absorption liquid S flowing down along the sidewall of the absorber 4 hardly absorbs sulfur oxide. Therefore, there is a tendency to increase the amount of the liquid which is necessary to be sprayed from the spray nozzles 9 for obtaining a required desulfurization rate.

FIG. 23 shows a cross section of the absorber 4 in the background-art wet flue gas desulfurization device. As shown in FIG. 23, when absorber 4 is cylindrical, the number of spray nozzles 9 placed in the periphery of the sidewall surface of the absorber 4 is inevitably reduced. Thus, the liquid density of the absorption liquid S flowing down along the sidewall of the absorber 4 tends to be lower (smaller) than that in a center portion of the absorber 4. The downward absorption liquid spray angles α (see FIG. 22) of the spray nozzles 9 designated by the white circles in FIG. 23 are about 90 to 120 degrees.

In this manner, when there occurs a deviation in the liquid density of the absorption liquid S sprayed in the respective stages in the absorber 4, a large proportion of the exhaust gas 1 from the boiler or the like flows in a part with a low liquid density, that is, in the vicinities of the sidewall of the absorber 4. Thus, there is a problem that satisfactory gas-liquid contact is not performed partially so that the performance to absorb sulfur oxide etc. in the exhaust gas 1 is partially lowered to affect the desulfurization performance of the absorber as a whole.

As a measure to solve the problem, an invention in which a gas blow-out (gas short pass) prevention member 19 consisting of a ring-like plate is placed along the entire circumference of a sidewall portion of an absorber 4 as shown in FIG. 24 so that an absorption liquid S flowing down along the sidewall can be blown off to the center portion of the absorber 4, has been proposed in Patent Literature 1.

In addition, a proposal has been made in Patent Document 2 that noses like a U-shape (gas blow-out (gas short pass) prevention member) are disposed in different stages on the sidewall surface of the absorber 4 so as not to overlap each other vertically in order to prevent a loss in pressure of a gas upward flow inside the absorber 4 from increasing due to formation of a liquid membrane starting at an inner peripheral end of the gas blow-out (gas short pass) prevention member 19 consisting of a ring-like plate when the absorption liquid S flowing down along the inner surface of the sidewall of the absorber 4 is blown off to the center portion of the absorber 4.

### CITATION LIST

### Patent Literature

Patent Document 1: U.S. Pat. No. 6,550,751
Patent Document 2: PCT/JP2007/068168

### SUMMARY OF INVENTION

### Technical Problem

In the absorber 4 having the gas blow-out (gas short pass) prevention member 19 placed along the entire circumference of the sidewall portion as described in the aforementioned Patent Literature 1 (U.S. Pat. No. 6,550,751), a liquid membrane starting at the inner peripheral end of the gas blow-out (gas short pass) prevention member 19 is formed when the absorption liquid S flowing down along the sidewall of the absorber 4 and reaching the top surface of the gas blow-out (gas short pass) prevention member 19 is blown off to the center portion of the absorber 4.

The liquid membrane is formed as a liquid membrane having a continuous and uniform thickness in the absorber 4. The liquid membrane is not split but flows down in the absorber 4. As a result, pressure loss is increased due to collision between the exhaust gas 1 and the liquid membrane in the gas inlet portion 3 of the absorber 4. In addition, inside the absorber 4, the cross-sectional area where gas can pass the inside of the absorber 4 is suppressed by the continuous liquid membrane. As a result, the gas flow rate in the absorber 4 increases. Based on this fact, there is a problem that the power consumption of an exhaust gas fan increases to increase the running cost.

On the other hand, the aforementioned Patent Literature 2 (PCT/JP2007/068168) has disclosed that noses like a U-shape (gas blow-out (gas short pass) prevention member) are disposed in different stages in the upper portion of the gas inlet in the absorber so as not to overlap each other vertically in order to prevent the pressure loss from increasing due to the liquid membrane. However, the noses (gas blow-out (gas short pass) prevention member) are not placed over the entire circumference of the absorption sidewall surface. Therefore, there is a problem that exhaust gas may take a short cut through a portion where the gas blow-out (gas short pass) prevention member is absent, in the sidewall portion.

In addition, the gas blow-out (gas short pass) prevention member is fixed directly to a body of the absorber by welding. Therefore, in addition to a problem in execution performance at the time of construction, there is another problem in poor performance for replacing or repairing the gas blow-out (gas short pass) prevention member that has been once placed.

In order to solve such defects in the background art, an object of the invention is to provide a wet flue gas desulfurization device by which high desulfurization performance can be obtained and which has low pressure loss in an absorber and low running cost.

### Solution to Problem

In order to attain the object, according to a first means of the invention, there is provided a wet flue gas desulfurization device including an absorber which is provided with: an absorber tank which is provided in a lower part of the absorber so as to store an absorption liquid; an absorption portion which is provided above the absorber tank and has multiple stages of spray headers for spraying the absorption liquid; an absorption liquid circulation system which circulates the absorption liquid in the absorber tank to the spray headers; an exhaust gas inlet portion which is provided in a sidewall between the liquid reservoir portion and the absorption portion; and a gas blow-out (gas short pass) prevention member which is provided along an entire circumference of an inner surface of the sidewall between the exhaust gas inlet portion and the uppermost-stage spray header; characterized in that: dams are intermittently provided at an inner peripheral end of the gas blow-out (gas short pass) prevention member to extend along the circumferential direction of the gas blow-out (gas short pass) prevention member.

According to a second means of the invention, there is provided a wet flue gas desulfurization device according to the first means, characterized in that: a total length of the dams provided at the inner peripheral end of the gas blow-out (gas short pass) prevention member is longer than a total length of portions where the dams are absent from the inner peripheral end of the gas blow-out (gas short pass) prevention member.

According to a third means of the invention, there is provided a wet flue gas desulfurization device including an absorber which is provided with: a absorber tank which is provided in a lower part of the absorber so as to store an absorption liquid; an absorption portion which is provided above the absorber tank and has multiple stages of spray headers for spraying the absorption liquid; an absorption liquid circulation system which circulates the absorption liquid in the absorber tank to the spray headers; an exhaust gas inlet portion which is provided in a sidewall between the absorber tank and the absorption portion; and a gas blow-out (gas short pass) prevention member which is provided along an entire circumference of an inner surface of the sidewall between the exhaust gas inlet portion and the uppermost-stage spray header; characterized in that: a dam is continuously provided at an entire inner peripheral end of the gas blow-out (gas short pass) prevention member so that a gap is formed between an outer peripheral end of the gas blow-out (gas short pass) prevention member and the inner surface of the sidewall of the absorber.

According to a fourth means of the invention, there is provided a wet flue gas desulfurization device including an absorber which is provided with: a absorber tank which is provided in a lower part of the absorber so as to store an absorption liquid; an absorption portion which is provided above the absorber tank and has multiple stages of spray headers for spraying the absorption liquid; an absorption liquid circulation system which circulates the absorption liquid in the absorber tank to the spray headers; an exhaust gas inlet portion which is provided in a sidewall between the absorber tank and the absorption portion; and a gas blow-out (gas short pass) prevention member which is provided along an entire circumference of an inner surface of the sidewall between the exhaust gas inlet portion and the uppermost-stage spray header; characterized in that: a dam is continuously provided at an entire inner peripheral end of the gas blow-out (gas short pass) prevention member; and spray holes for spraying the absorption liquid staying on the gas blow-out (gas short pass) prevention member are formed in the gas blow-out (gas short pass) prevention member or a lower part of the dam.

According to a fifth means of the invention, there is provided a wet flue gas desulfurization device including an absorber which is provided with: a liquid reservoir portion which is provided in a lower part of the absorber so as to store an absorption liquid; an absorption portion which is provided above the absorber tank and has multiple stages of spray headers for spraying the absorption liquid; an absorption liquid circulation system which circulates the absorption liquid in the absorber tank to the spray headers; an exhaust gas inlet portion which is provided in a sidewall between the absorber tank and the absorption portion; and a gas blow-out (gas short pass) prevention member which is provided along an entire circumference of an inner surface of the sidewall between the exhaust gas inlet portion and the uppermost-stage spray header; characterized in that: a dam is continuously provided at an entire inner peripheral end of the gas blow-out (gas short pass) prevention member; and a liquid return duct for returning the absorption liquid staying on the gas blow-out (gas short pass) prevention member to the absorber tank is connected to the gas blow-out (gas short pass) prevention member.

According to a sixth means of the invention, there is provided a wet flue gas desulfurization device according to any one of the first through fifth means, characterized in that: a mounting lug is fixed to the sidewall of the absorption tower so as to extend along the circumferential direction of the inner surface of the sidewall of the absorber; and the gas blow-out (gas short pass) prevention member is mounted on the lug so as to be fixed not to the sidewall of the absorber but to the lug.

### Advantageous Effects of Invention

According to the invention configured thus, it is possible to provide a wet flue gas desulfurization device by which high desulfurization performance can be obtained and which has low pressure loss in an absorber and low running cost.

### BRIEF DESCRIPTION OF DRAWINGS

FIG. 1 A horizontally sectional view showing the inside of an absorber according to Example 1 of the invention.

FIG. 2 A vertically sectional view taken on line X-X in FIG. 1.

FIG. 3 Vertically enlarged sectional views of a gas blow-out (gas short pass) prevention member attached to the absorber.

FIG. 4 Vertically enlarged sectional views each showing another way to attach the gas blow-out (gas short pass) prevention member.

FIG. 5 A horizontally sectional view for explaining a structure in which the gas blow-out (gas short pass) prevention member is attached to the absorber.

FIG. 6 A vertically enlarged sectional view showing a lug with a support member.

FIG. 7 A vertically enlarged sectional view showing a lug with no support member.

FIG. 8 A vertically enlarged sectional view showing an inclined lug.

FIG. 9 A horizontally sectional view showing the inside of the absorber when a wet flue gas desulfurization device is operating.

FIG. 10 A vertically enlarged sectional view taken on line X-X in FIG. 6.

FIGS. 11 (a) and (b) are vertically enlarged sectional views showing the condition of a portion of the gas blow-out (gas short pass) prevention member provided with a dam and the condition of a portion of the gas blow-out (gas short pass) prevention member provided with no dam, respectively, when a wet flue gas desulfurization device is operating.

FIG. 12 A horizontally sectional view showing the inside of an absorber according to Example 2 of the invention.

FIG. 13 A characteristic graph showing the relationship between the amount of an absorption liquid flowing down and the pressure loss in an absorber when each of a wet flue gas desulfurization device as an inventive product and background-art wet flue gas desulfurization devices as background-art products 1 and 2 is operating.

FIG. 14 A horizontally sectional view showing the inside of an absorption tower according to Example 3 of the invention.

FIG. 15 An enlarged horizontally sectional view showing the inside of an absorber according to Example 4 of the invention.

FIG. 16 A vertically enlarged sectional view showing the vicinities of a gas blow-out (gas short pass) prevention member placed in the absorber when a wet flue gas desulfurization device is operating.

FIG. 17 An enlarged horizontally sectional view showing the inside of an absorption tower according to Example 5 of the invention.

FIG. 18 A vertically enlarged sectional view showing the vicinities of a porous gas blow-out (gas short pass) prevention member placed in the absorber when a wet flue gas desulfurization device is operating.

FIG. 19 A horizontally sectional view showing the inside of an absorber according to Example 6 of the invention.

FIG. 20 A vertically sectional view showing the inside of the absorber.

FIG. 21 A vertically enlarged sectional view showing the vicinities of a ducting-including gas blow-out (gas short pass) prevention member attached to the absorber when a wet flue gas desulfurization device is operating.

FIG. 22 A system diagram of a wet flue gas desulfurization device.

FIG. 23 A horizontally sectional view of an absorber in a background-art wet flue gas desulfurization device.

FIG. 24 A partially perspective view of an absorber in a wet flue gas desulfurization device proposed in the background art.

### DESCRIPTION OF EMBODIMENTS

Each of the first to fifth configurations of the invention which will be described below is aimed at a wet flue gas desulfurization device as a means for removing sulfur oxide contained in exhaust gas discharged from a boiler or the like installed in a thermal power plant, a factory or the like. The wet flue gas desulfurization device is configured in such a manner that a gas inlet portion for introducing exhaust gas is formed in a sidewall of an absorber, spray headers for spraying an absorption liquid to the exhaust gas rising inside the absorber from the gas inlet portion are provided in multiple stages so as to extend along the gas flow direction, and a gas blow-out (gas short pass) prevention member is placed along an entire circumference of an inner surface of the sidewall of the absorber above the gas inlet portion.

The first configuration of the invention is characterized in that portions provided with dams and portions provided with no dams are disposed alternately at an inner peripheral end of the gas blow-out (gas short pass) prevention member.

When the gas blow-out (gas short pass) prevention member is provided along the entire circumference of the inner surface of the sidewall of the absorber as described above, the exhaust gas which tries to take a short cut along the sidewall of the absorber can be directed to the center of the absorber to prevent the exhaust gas from drifting. Further, the absorption liquid flowing down along the sidewall of the absorber is received by the gas blow-out (gas short pass) prevention member and blown off from the gas blow-out (gas short pass) prevention member toward the center portion of the absorber. Thus, the efficiency of gas-liquid contact between the exhaust gas and the absorption liquid can be improved.

Further, when the structure of the gas blow-out (gas short pass) prevention member is formed so that the portions provided with the dams and the portions provided with no dams are disposed alternately at the inner peripheral end of the gas blow-out (gas short pass) prevention member, the absorption liquid flowing down to the portions provided with the dams can flow to the portions provided with no dams. In the portions provided with no dams, the absorption liquid blown off from the inner peripheral end of the gag blow-out prevention member is formed into a liquid membrane and flows down to the inside of the absorber. However, the liquid membrane is not a liquid membrane which is continuous in the circumferential direction and uniform in thickness. The exhaust gas can pass through the portions where no membrane is formed. Thus, it is possible to suppress large increase in pressure loss.

The second configuration of the invention is characterized in that a dam is continuously provided at an entire inner peripheral end of the gas blow-out (gas short pass) prevention member so that a gap is formed between an outer peripheral end of the gas blow-out (gas short pass) prevention member and the inner surface of the sidewall of the absorber.

In the same manner as in the first configuration of the invention, the gas blow-out (gas short pass) prevention member is disposed along the entire circumference of the inner surface of the absorber so that the exhaust gas which tries to take a short cut through the sidewall of the absorber can be directed to the center of the absorber. Thus, the exhaust gas can be prevented from drifting.

Further, since the dam is attached to the entire inner peripheral end of the gas blow-out (gas short pass) prevention member, the absorption liquid flowing down onto the gas blow-out (gas short pass) prevention member along the inner surface of the sidewall of the absorber is not blown off as a continuous liquid membrane inside the absorber, which membrane starts at the inner peripheral end of the gas blow-out (gas short pass) prevention member. The absorption liquid flows down through the gap formed between the sidewall of the absorber and the gas blow-out (gas short pass) prevention member, and reaches the absorber tank along the sidewall of the absorber so as to be recovered in the absorber tank. Thus, it is possible to suppress increase in pressure loss of the absorber.

The third configuration of the invention is characterized in that a dam is continuously provided at an entire inner peripheral end of the gas blow-out (gas short pass) prevention member, and spray holes for spraying the absorption liquid staying on the gas blow-out (gas short pass) prevention member are formed in the gas blow-out (gas short pass) prevention member or a lower part of the dam.

In the same manner as in the first configuration of the invention, the gas blow-out (gas short pass) prevention member is disposed along the entire circumference of the inner surface of the sidewall of the absorber so that the exhaust gas which tries to take a short cut through the sidewall of the absorber can be directed to the center of the absorber. Thus, the exhaust gas can be prevented from drifting.

Further, since the dam is attached to the entire inner peripheral end of the gas blow-out (gas short pass) prevention member, the absorption liquid flowing down onto the gas blow-out (gas short pass) prevention member along the inner surface of the sidewall of the absorber is not blown off as a continuous liquid membrane inside the absorber, which membrane starts at the inner peripheral end of the gas blow-out (gas short pass) prevention member. Parts of the absorption liquid from the spray holes formed in the gas blow-out (gas short pass) prevention member are not formed into a continuous liquid membrane but flow down to be recovered individually in the absorber tank. Thus, it is possible to suppress increase in pressure loss of the absorber.

The fourth configuration of the invention is characterized in that a dam is continuously provided at an entire inner peripheral end of the gas blow-out (gas short pass) prevention member, and each of liquid return ducts for returning the absorption liquid staying on the gas blow-out (gas short pass) prevention member to the absorber tank is connected to the gas blow-out (gas short pass) prevention member.

In the same manner as in the first configuration of the invention, the gas blow-out (gas short pass) prevention member is disposed along the entire circumference of the inner surface of the absorber so that the exhaust gas which tries to take a short cut through the sidewall of the absorber can be directed to the center of the absorber. Thus, the exhaust gas can be prevented from drifting.

Further, since the dam is attached to the entire inner peripheral end of the gas blow-out (gas short pass) prevention member, the absorption liquid flowing down onto the gas blow-out (gas short pass) prevention member along the inner surface of the sidewall of the absorber is not blown off as a continuous liquid membrane inside the absorber, which membrane starts at the inner peripheral end of the gas blow-out (gas short pass) prevention member. Parts of the absorption liquid are not formed into a continuous liquid membrane but flow down individually through the liquid return ducts provided in the gas blow-out (gas short pass) prevention member so as to be recovered in the absorber tank. Thus, it is possible to suppress increase in pressure loss of the absorber.

The fifth configuration of the invention is characterized in that a mounting lug is fixed to the sidewall of the absorber so as to extend along the circumferential direction of the inner surface of the sidewall of the absorber, and the gas blow-out prevention member is mounted on the lug so as to be fixed not to the sidewall of the absorber but to the lug.

It is therefore unnecessary to fix the gas blow-out (gas short pass) prevention member to the wall surface of the absorber body by welding so that the performance of on-site execution is improved while the gas blow-out (gas short pass) prevention member can be replaced easily even after the passage of time. Thus, the maintenability can be improved.

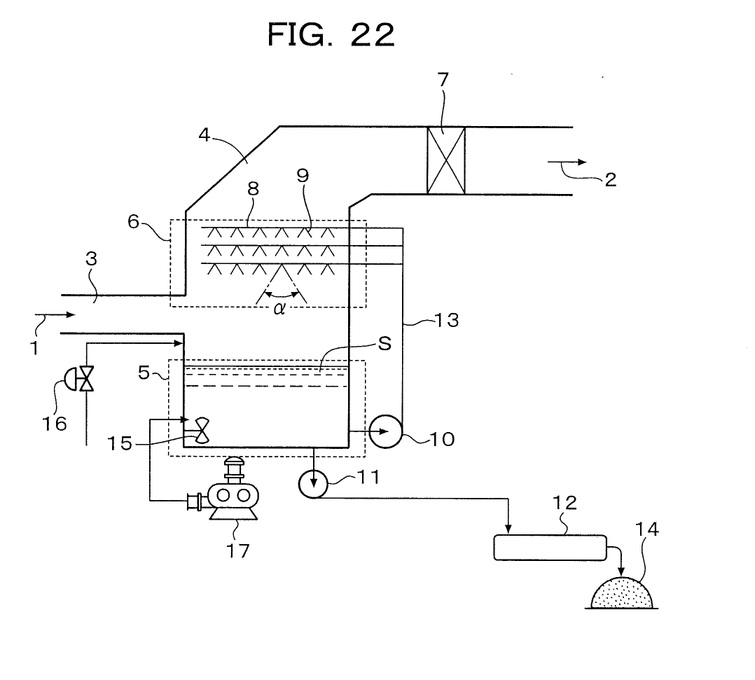

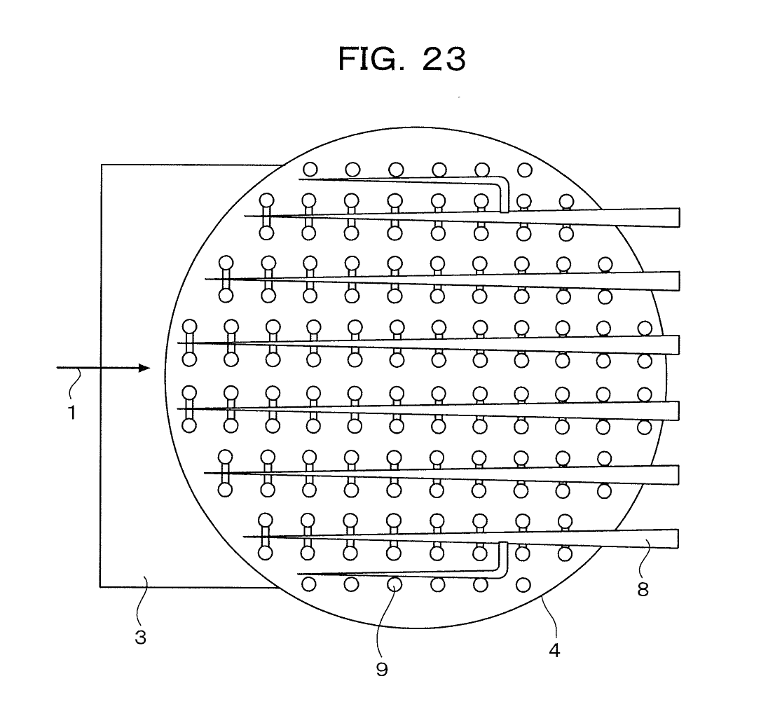

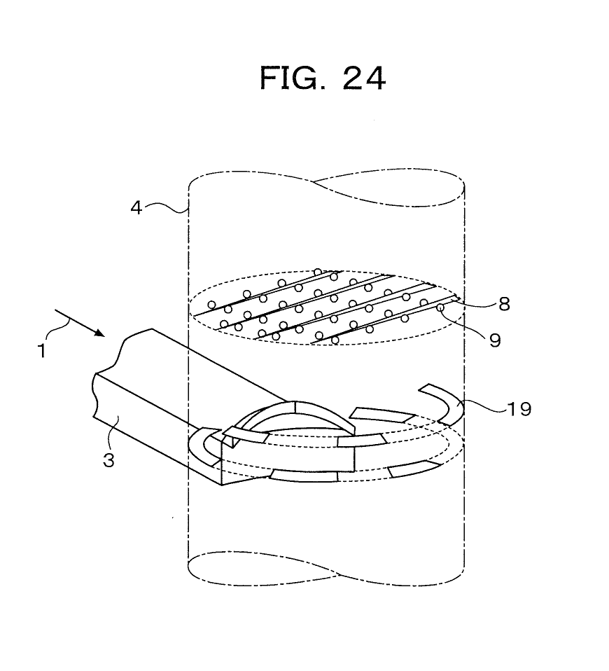

Next, Examples of the invention will be described with reference to the drawings. An overall system of a wet flue gas desulfurization device in a thermal power plant is substantially the same as that shown in FIG. 22, so that description thereof will be omitted.

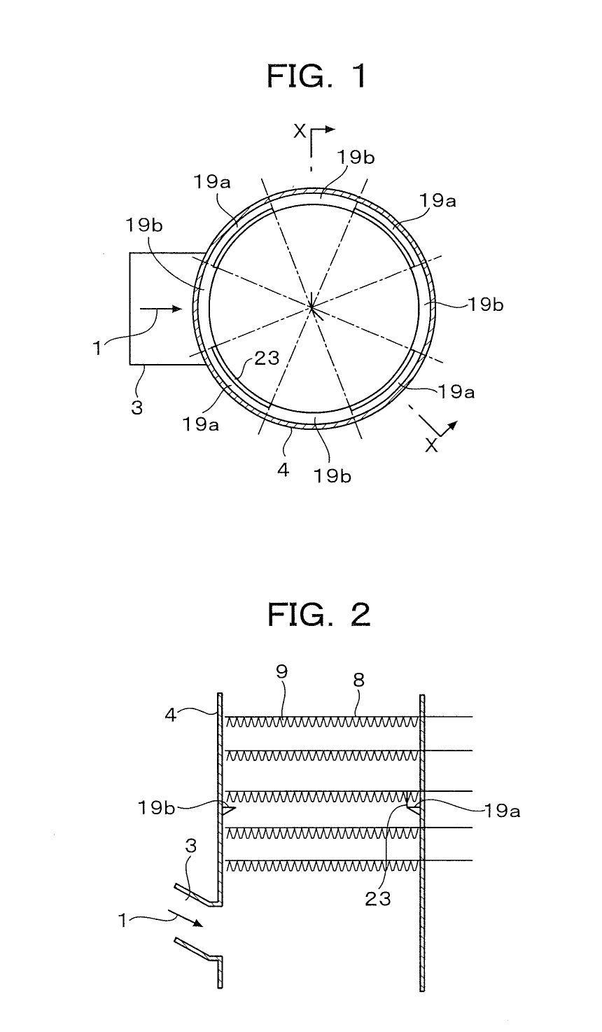

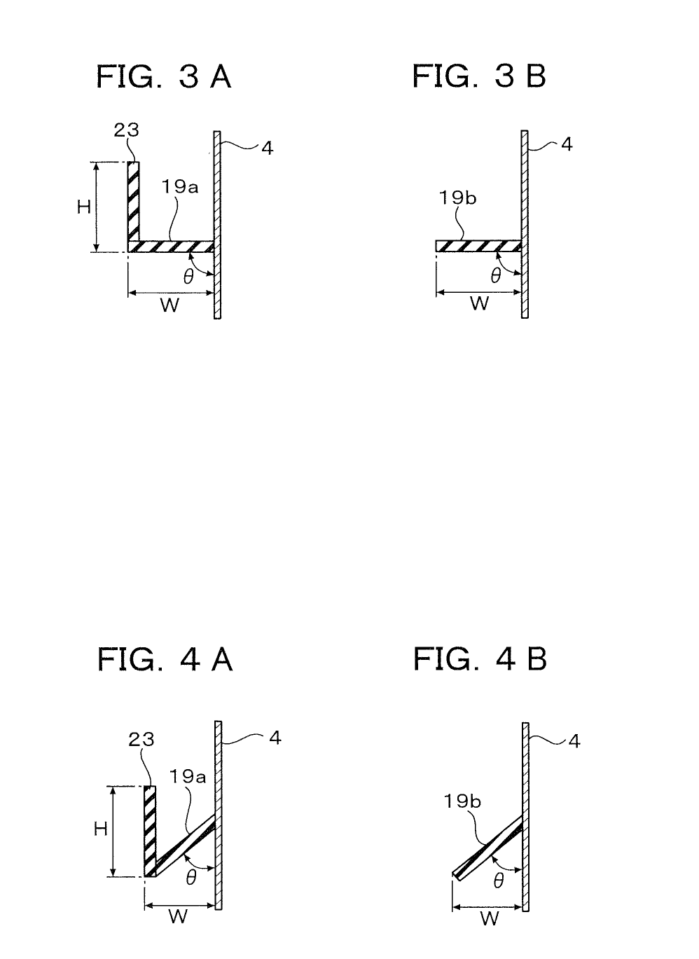

FIG. 1 is a horizontally sectional view showing the inside of an absorber according to Example 1 of the invention. FIG. 2 is a vertically sectional view taken on line X-X in FIG. 1. FIGS. 3(a) and 3(b) are vertically enlarged sectional views of a gas blow-out (gas short pass) prevention member attached to the absorber.

As shown in FIG. 2, a gas blow-out (gas short pass) prevention member 19 is provided on the inner side of a sidewall of an absorber 4 above a gas inlet portion 3 of the absorber 4 and under an uppermost-stage spray header 8 so as to extend along the entire circumference of the absorber 4 and face the inner side of the absorber 4.

Portions 19a provided with dams 23 and portions 19b provided with no dams 23 are provided alternately in an inner peripheral end of the gas blow-out (gas short pass) prevention member 19 so as to extend along the circumferential direction of the absorber 4. That is, the dams 23 are intermittently provided in the inner peripheral end of the gas blow-out (gas short pass) prevention member 19. In the case of this Example, as shown in FIG. 1, the entire circumference of the absorber 4 is divided equally into eight, and four portions 19a provided with the dams 23 and four portions 19b provided with no dams 23 are formed alternately.

FIGS. 3(a) and 3(b) show an example in which an attachment angle θ of the dams 23 to the sidewall of the absorber 4 is about 90 degrees. FIGS. 4(a) and 4(b) show an example in which the attachment angle θ of the dams 23 is smaller than 90 degrees, for example, about 30 to 60 degrees. The attachment angle θ of the dams 23 may be set to be larger than 90 degrees.

The width W and attachment angle θ of the gas blow-out (gas short pass) prevention member 19 and the height H of the dams 23 shown in FIG. 3 and FIG. 4 are not defined especially but may be set at any size and any angle. In addition, the attachment ranges of the dams 23 (the ranges of the portions 19a provided with the dams 23 and the ranges of the portions 19b provided with no dams 23) are not defined especially, but may be set at any sizes.

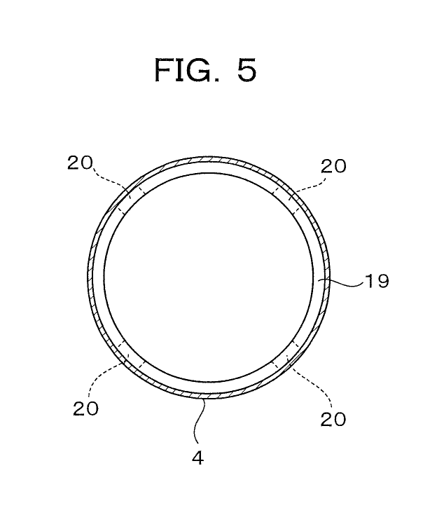

FIG. 5 is a horizontally sectional view for explaining a structure in which the gas blow-out (gas short pass) prevention member 19 is attached to the body of the absorber 4. In FIG. 5, the dams 23 are omitted for the sake of simplification of the drawing.

A plurality (four in this Example) of lugs 20 are attached to the inner side of the sidewall of the body of the absorber 4 above the gas inlet portion 3 and arranged at an equal interval, for example, by means of welding or the like. The gas blow-out (gas short pass) prevention member 19 is mounted on the lugs 20 and fixed to the lugs 20 by suitable means of bolts, welding or the like. The gas blow-out (gas short pass) prevention member 19 has a structure in which the gas blow-out (gas short pass) prevention member 19 is not fixed directly to the body of the absorber 4 by welding or the like. This is because the performance of on-site execution can be improved while such maintenability that the gas blow-out (gas short pass) prevention member 19 can be replaced easily after the passage of time can be improved.

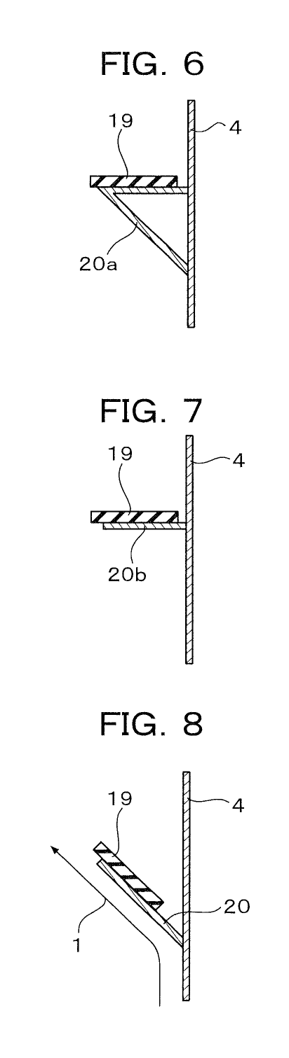

Lugs 20a with inclined support members as shown in FIG. 6, lugs 20b with no support members as shown in FIG. 7, etc. are used as the lugs 20. The number of lugs 20 placed, the length thereof, etc. are set arbitrarily. The lugs 20 are attached to the sidewall surface of the absorber 4 roughly perpendicularly in the examples of FIGS. 6 and 7. However, when the gas blow-out (gas short pass) prevention member 19 is provided to be inclined with respect to the sidewall surface of the absorber 4 as shown in FIG. 8, the lugs 20 have to be also provided to be inclined correspondingly. When the gas blow-out (gas short pass) prevention member 19 is provided to be inclined toward the center portion of the absorber 4 so that the inner peripheral end of the gas blow-out (gas short pass) prevention member 19 is higher than the outer peripheral end thereof, the flow of the exhaust gas 1 rising along the sidewall of the absorber 4 can be directed to the center portion of the absorber 4.

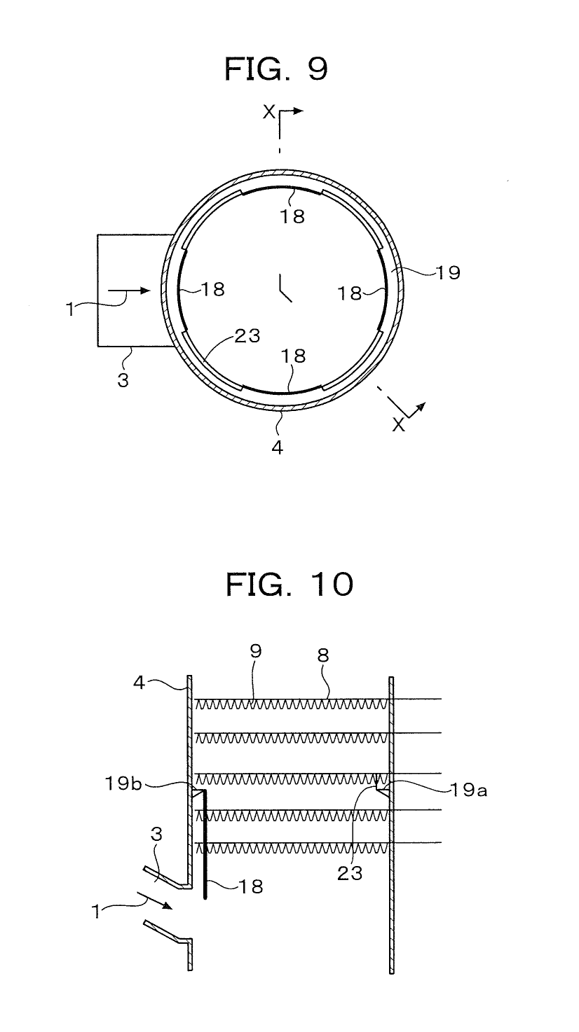

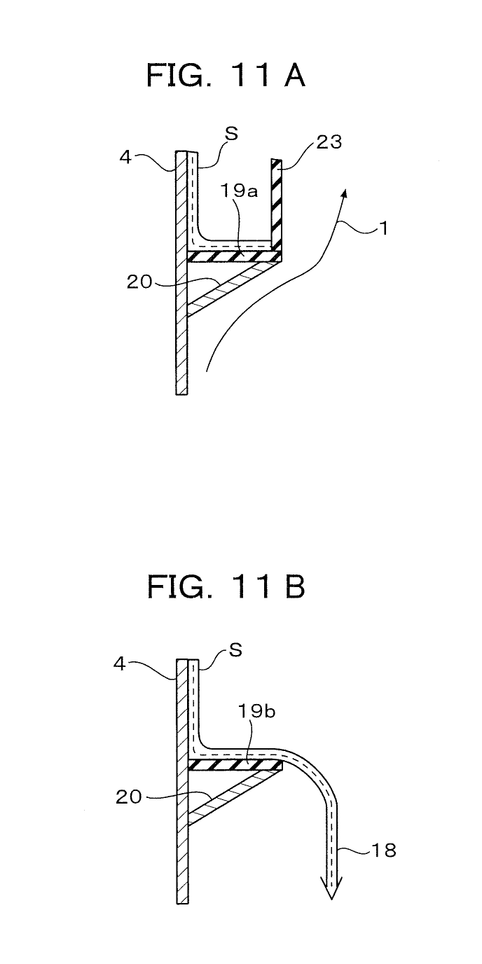

FIGS. 9 to 11 are views for explaining the state in which the wet flue gas desulfurization device is operating. FIG. 9 is a horizontally sectional view showing the inside of the absorber 4. FIG. 10 is a vertically enlarged sectional view taken on line X-X in FIG. 9. FIGS. 11(a) and 11(b) are vertically enlarged sectional views showing the state of the portion 19a of the gas blow-out (gas short pass) prevention member provided with a dam and the state of the portion 19b of the gas blow-out (gas short pass) prevention member provided with no dam, respectively.

As described previously, in FIG. 22, the exhaust gas 1 generated by a boiler or the like installed in a thermal power plant, a factory or the like is introduced into the absorber 4 from the gas inlet portion 3. On the other hand, the slurry-like absorption liquid S stored in the absorber tank 5 is boosted in pressure by the absorber circulation pump 10, and supplied through the absorber circulation pipe 13 to the spray headers 8 which are provided in multiple stages in an upper empty tower part inside the absorber 4 to extend along the flow direction of the exhaust gas 1. A large number of spray nozzles 9 are provided in each spray header 8. Due to gas-liquid contact between the absorption liquid S sprayed from the spray nozzles 9 and the exhaust gas 1, acidic gas contained in the exhaust gas, such as sulfur oxide, hydrogen chloride, hydrogen fluoride, etc., is absorbed in the surfaces of droplets of the absorption liquid S.

In the absorber 4 according to this Example, the gas blow-out (gas short pass) prevention member 19 is placed along the entire circumference of the sidewall of the absorber 4. The exhaust gas 1 which tries to take a short cut along the sidewall of the absorber 4 is directed to the center of the absorber 4 so that the exhaust gas 1 can be prevented from drifting, as shown in FIG. 11(a). Thus, the exhaust gas 1 can be prevented from taking a short cut.

On the other hand, the absorption liquid S flowing down along the sidewall of the absorber 4 is changed in flow direction by the gas blow-out (gas short pass) prevention member 19 provided on the way of the sidewall as shown in FIG. 11(b). Thus, the absorption liquid S is blown off to the center portion of the absorber 4. Since the aforementioned gas blow-out (gas short pass) prevention member 19 prevents the exhaust gas 1 from drifting and blows off the absorption liquid S to the center portion of the absorber, the efficiency of the gas-liquid contact between the exhaust gas 1 and the absorption liquid S can be enhanced.

Further, the gas blow-out (gas short pass) prevention member 19 is formed in such a manner that the portions 19a provided with the dams 23 and the portions 19b provided with no dams 23 are disposed alternately. The absorption liquid S flowing down to the portions 19a provided with the dam 23 flows toward the portions 19b provided with no dams 23. In each portion 19b provided with no dam 23, the collected absorption liquid S is formed into a liquid membrane 18, which flows down from the inner peripheral end of the gas blow-out (gas short pass) prevention member 19 to the inside of the absorber 4, as shown in FIGS. 9 to FIG. 11(b).

At that time, as shown in FIG. 9, the liquid membrane 18 is formed in each portion 19b provided with no dam 23, and not formed in each portion 19a provided with the dam 23. Accordingly, the liquid membrane 18 is intermittently formed in the inner circumferential direction of the absorber 4. When the liquid membrane 18 is formed intermittently thus, the exhaust gas 1 including exhaust gas 1 which tries to take a short cut along the sidewall of the absorber 4 as shown in FIG. 11(a) passes through the portions where the liquid membrane 18 is not formed. It is therefore possible to suppress increase of pressure loss in the absorber 4.

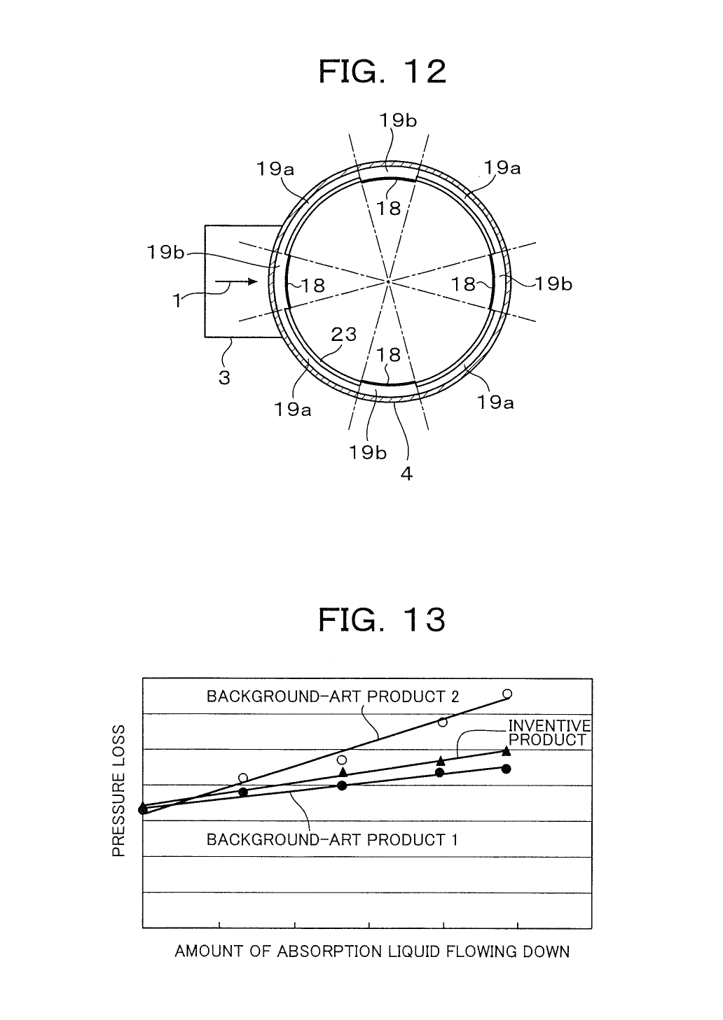

FIG. 12 is a horizontally sectional view showing the inside of an absorber according to Example 2 of the invention. This Example is different from the aforementioned Example 1 in that a total inner circumferential length L1 of the portions 19a to which the dams 23 are attached is longer than a total inner circumferential length L2 of the portions 19b where the dams 23 are absent in the circumferential direction of the gas blow-out (gas short pass) prevention member 19 (L1>L2).

FIG. 13 is a characteristic graph obtained by comparison of the relationship between the amount of an absorption liquid flowing down and the pressure loss between an inlet and an outlet of an absorber, among the case where the absorber is an absorber (inventive product) according to this Example 2, the case where the absorber is an absorber (background-art product 2) in which a gas blow-out (gas short pass) prevention member provided with no dam in its inner peripheral end is placed, and the case where the absorber is an absorber (background-art product 1) in which no gas blow-out (gas short pass) prevention member is placed. In the graph, the black triangles designate the absorber (inventive product) according to Example 2 of the invention, the white circles designate the absorber (background-art product 2) in which a gas blow-out (gas short pass) prevention member provided with no dam in its inner peripheral end is placed, and the black circles designate the absorber (background-art product 1) in which no gas blow-out (gas short pass) prevention member is placed.

As is apparent from the graph, a liquid membrane is formed out of the absorption liquid continuously along the entire inner circumference of the absorber in the case of the absorber (background-art product 2) using a gas blow-out (gas short pass) prevention member provided with no dam, as designated by the white circles. As a result, the cross-sectional area the exhaust gas passing through the inside of the absorber can pass is suppressed and narrowed to increase the flow rate of the gas in the tower. Thus, there is a problem that the pressure loss in the absorber increases, and the power consumption of an exhaust gas fan increases. The tendency of the increase in pressure loss becomes conspicuous with the increase in the flow rate of the absorption liquid flowing down, as shown in FIG. 13.

On the other hand, in the case of the absorber (background-art product 1) in which no gas blow-out (gas short pass) prevention member is placed, the cross-sectional area the exhaust gas passing through the inside of the absorber can pass is not suppressed but the pressure loss in the absorber can be suppressed to be low. However, the exhaust gas takes a short cut in the absorber to generate a drift of the exhaust gas. Thus, there is a problem that the efficiency in contact between the exhaust gas and the absorption liquid is poor.

On the contrary, the inventive product has a pressure loss which is slightly higher than the background-art product 1 and not higher than that in the background-art product 2. In addition, the efficiency in contact between the exhaust gas and the absorption liquid is so good that a high desulfurization effect can be obtained.

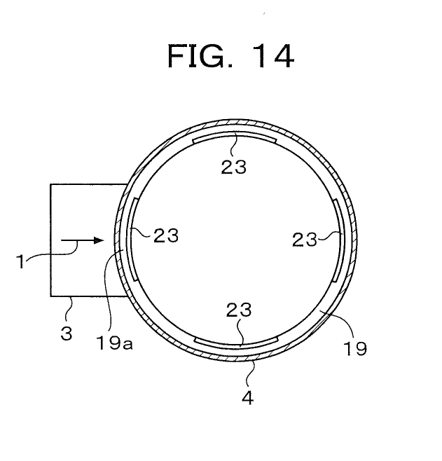

FIG. 14 is a horizontally sectional view showing the inside of an absorber 4 according to Example 3 of the invention, which tower is different from the absorber 4 according to Example 1 shown in FIG. 1 in that each dam 23 placed on the gas blow-out (gas short pass) prevention member 19 is about 45 degrees displaced circumferentially from that in the absorber 4 shown in FIG. 1, and the portions 19a provided with the dams 23 are disposed above the gas inlet portion 3 formed in the sidewall of the absorber 4.

As shown in FIG. 11(a), the liquid membrane 18 of the absorption liquid S is not formed on the portions 19a provided with the dams 23. Thus, the exhaust gas 1 can be introduced smoothly from the gas inlet portion 3. In the example shown in FIG. 4, the lateral width of each dam 23 is a little narrower than the lateral width of the gas inlet portion 3. However, the lateral width of each dam 23 may be made substantially equal to or slightly longer than the lateral width of the gas inlet portion 3.

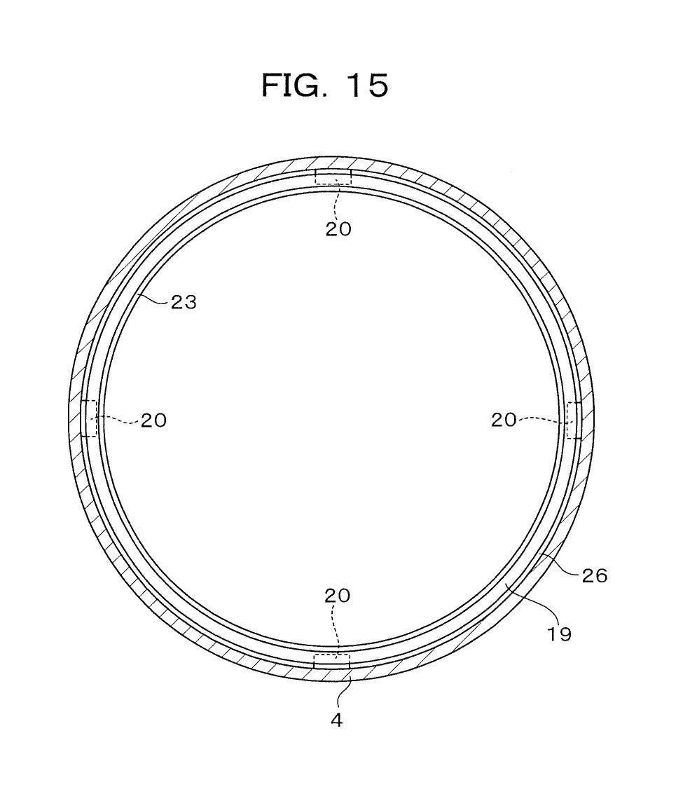

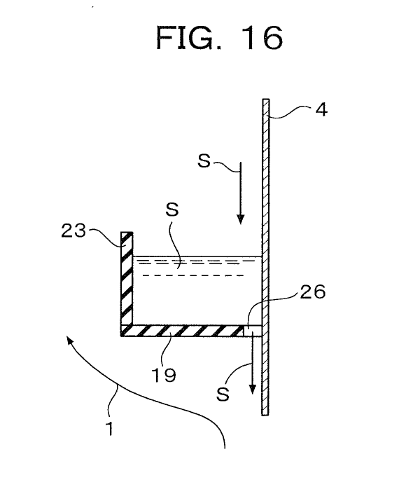

FIG. 15 is an enlarged horizontally sectional view showing the inside of an absorber 4 according to Example 4 of the invention. FIG. 16 is a vertically enlarged sectional view showing the vicinities of a gas blow-out (gas short pass) prevention member 19 placed in the absorber 4 when a wet flue gas desulfurization device is operating.

In the case of this Example, a dam 23 is attached to the entire inner circumference of the gas blow-out (gas short pass) prevention member 19, and further a continuous (this Example) or intermittent gap 26 is formed between the sidewall of the absorber 4 and the gas blow-out (gas short pass) prevention member 19.

According to this Example, as shown in FIG. 16, the exhaust gas 1 can be prevented from drifting because the gas blow-out (gas short pass) prevention member 19 is placed. Thus, the exhaust gas 1 is guided into the center portion of the absorber 4. On the other hand, the absorption liquid S flowing down along the inner surface of the sidewall of the absorber 4 is once stored on the gas blow-out (gas short pass) prevention member 19 dammed by the dam 23. The stored absorption liquid S passes through the gap 26 and flows down along the sidewall of the absorber 4 again. Due to the absorption liquid S stored on the gas blow-out (gas short pass) prevention member 19, there is no fear that the exhaust gas 1 is blown out through the gap 26.

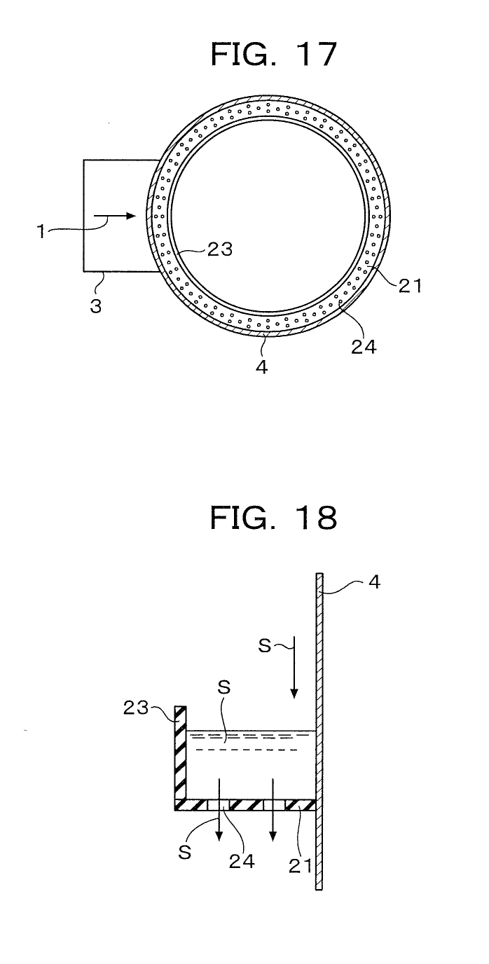

FIG. 17 is an enlarged horizontally sectional view showing the inside of an absorber 4 according to Example 5 of the invention. FIG. 18 is a vertically enlarged sectional view showing the vicinities of a porous gas blow-out (gas short pass) prevention member 21 placed in the absorber 4 when a wet flue gas desulfurization device is operating.

In the case of this Example, as shown in FIG. 17, the porous gas blow-out (gas short pass) prevention member 21 in which a large number of spray holes 24 are formed all over the surface thereof is used, and a dam 23 is attached to the inner circumference of the porous gas blow-out (gas short pass) prevention member 21.

In the case of this Example, as shown in FIG. 18, the absorption liquid S flowing down along the inner surface of the sidewall of the absorber 4 is once stored on the porous gas blow-out (gas short pass) prevention member 21 dammed by the dam 23. The stored absorption liquid S is sprayed again from the aforementioned spray holes 24 so as not to be formed into a continuous liquid membrane. Thus, the flow of the exhaust gas 1 is not limited by the liquid membrane, but the increase in pressure loss can be suppressed. Also in the case of this Example, since the absorption liquid S is stored on the gas blow-out (gas short pass) prevention member 21, there is no fear that the exhaust gas 1 is blown out through the spray holes 24.

Although the porous gas blow-out (gas short pass) prevention member 21 is used in this Example, the same effect can be obtained even when a plate-like gas blow-out (gas short pass) prevention member 19 is used and the spray holes 24 are formed on the lower part side of the dam 23.

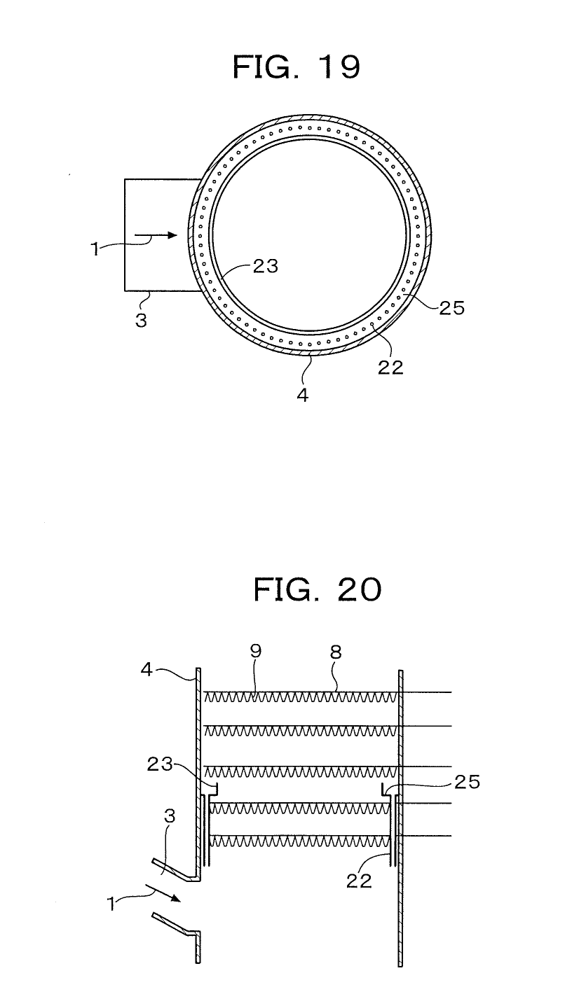

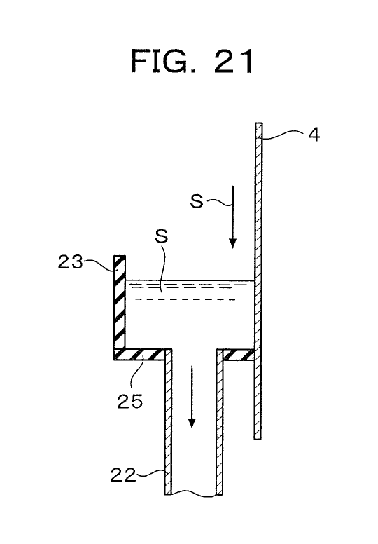

FIG. 19 is a horizontally sectional view showing the inside of an absorber 4 according to Example 6 of the invention. FIG. 20 is a vertically sectional view showing the inside of the absorber 4. FIG. 21 is a vertically enlarged sectional view showing the vicinities of a duct-including gas blow-out (gas short pass) prevention member 25 attached to the absorber 4 when a wet flue gas desulfurization device is operating.

In the case of this Example, as shown in FIG. 19, the duct-including gas blow-out (gas short pass) prevention member 25 in which a large number of liquid return ducts 22 are provided downward over the entire surface thereof is used, and a dame is provided erectly on an inner peripheral end of the duct-including gas blow-out (gas short pass) prevention member 25. As shown in FIG. 20, lower ends of the liquid return ducts 22 extend to be further lower than the lowermost-tier spray header 8.

In the case of this Example, as shown in FIG. 21, the absorption liquid S flowing down along the inner surface of the sidewall of the absorber 4 is once stored on the gas blow-out (gas short pass) prevention member 25 dammed by the dam 23. Parts of the stored absorption liquid S are returned to the absorber tank 5 individually through the liquid return ducts 22 so as not to be formed into a continuous liquid membrane. Thus, the flow of the exhaust gas 1 is not limited by the liquid membrane so that the increase in pressure loss can be suppressed. Also in the case of this Example, since the absorption liquid S is stored on the gas blow-out (gas short pass) prevention member 25, there is no fear that the exhaust gas 1 is blown out through the liquid return ducts 22.

The absorption liquid S flowing out from the liquid return ducts 22 may flow along the sidewall of the absorber 4 so as to be returned to the absorber tank 5 because the lower ends of the liquid return ducts 22 are brought into contact with the sidewall of the absorber 4.

In the aforementioned Examples 4 to 6, a space portion formed by the sidewall of the absorber 4, the gas blow-out (gas short pass) prevention member 19, 21, 25, and the dam 23 is designed to have an enough size to prevent the absorption liquid S from getting over the dam 23 and falling down as a liquid membrane when the absorption liquid S is stored in the space portion.

### REFERENCE SIGNS LIST

1 . . . exhaust gas, 2 . . . exhaust gas, 3 . . . gas inlet portion, 4 . . . absorber, 5 . . . absorber tank, 6 . . . absorber absorption portion, 7 . . . mist eliminator, 8 . . . spray header, 9 . . . spray nozzle, 10 . . . circulation pump, 11 . . . bleed pump, 12 . . . gypsum dewatering equipment, 13 . . . absorption liquid circulation duct, 14 . . . gypsum, 15 . . . oxidation agitator, 16 . . . slurry flow rate control valve, 17 . . . air oxidation blower, 18 . . . liquid membrane, 19 . . . gas blow-out (gas short pass) prevention member, 19a . . . portion of gas blow-out (gas short pass) prevention member provided with dam, 19b portion of gas blow-out (gas short pass) prevention member provided with no dam, 20 . . . lug, 21 . . . porous gas blow-out (gas short pass) prevention member, 22 . . . liquid return duct, 23 . . . dam, 24 . . . spray hole, 25 . . . duct-including gas blow-out (gas short pass) prevention member, 26 . . . gap, and S . . . absorption liquid.

1. A wet flue gas desulfurization device, comprising:
an absorption tower which is provided with: a liquid reservoir portion which is provided in a lower part of the tower so as to store an absorption liquid; an absorption portion which is provided above the absorber tank and has multiple stages of spray headers for spraying the absorption liquid; an absorption liquid circulation system which circulates the absorption liquid in the liquid reservoir portion to the spray headers; an exhaust gas inlet portion which is provided in a sidewall between the absorber tank and the absorption portion; and a gas blow-out prevention member which is provided along an entire circumference of an inner surface of the sidewall between the exhaust gas inlet portion and the uppermost-tier spray header; wherein:
dams are intermittently provided at an inner peripheral end of the gas blow-out prevention member to extend along the circumferential direction of the gas blow-out prevention member.

2. A wet flue gas desulfurization device according to claim 1, wherein: a total length of the dams provided at the inner peripheral end of the gas blow-out prevention member is longer than a total length of portions of the inner peripheral end of the gas blow-out prevention member, where the dams are not provided.

3. A wet flue gas desulfurization device, comprising:
an absorber which is provided with: an absorber tank which is provided in a lower part of the absorber so as to store an absorption liquid; an absorption portion which is provided above the absorber tank and has multiple stages of spray headers for spraying the absorption liquid; an absorption liquid circulation system which circulates the absorption liquid in the absorber tank to the spray headers; an exhaust gas inlet portion which is provided in a sidewall between the absorber tank and the absorption portion; and a gas blow-out prevention member which is provided along an entire circumference of an inner surface of the sidewall between the exhaust gas inlet portion and the uppermost-tier spray header; wherein:
a dam is continuously provided at an entire inner peripheral end of the gas blow-out prevention member so that a gap is formed between an outer peripheral end of the gas blow-out prevention member and the inner surface of the sidewall of the absorber.

4. A wet flue gas desulfurization device, comprising,
an absorber which is provided with: an absorber tank which is provided in a lower part of the absorber so as to store an absorption liquid; an absorption portion which is provided above the absorber tank and has multiple stages of spray headers for spraying the absorption liquid; an absorption liquid circulation system which circulates the absorption liquid in the absorber tank to the spray headers; an exhaust gas inlet portion which is provided in a sidewall between the absorber tank and the absorption portion; and a gas blow-out prevention member which is provided along an entire circumference of an inner surface of the sidewall between the exhaust gas inlet portion and the uppermost-stage spray header; wherein:
a dam is continuously provided at an entire inner peripheral end of the gas blow-out prevention member; and spray holes for spraying the absorption liquid staying on the gas blow-out prevention member are formed in the gas blow-out prevention member or a lower part of the dam.

5. A wet flue gas desulfurization device, comprising:
an absorber which is provided with: an absorber tank which is provided in a lower part of the absorber so as to store an absorption liquid; an absorption portion which is provided above the absorber tank and has multiple stages of spray headers for spraying the absorption liquid; an absorption liquid circulation system which circulates the absorption liquid in the absorber tank to the spray headers; an exhaust gas inlet portion which is provided in a sidewall between the absorber tank and the absorption portion; and a gas blow-out prevention member which is provided along an entire circumference of an inner surface of the sidewall between the exhaust gas inlet portion and the uppermost-stage spray header; wherein:
a dam is continuously provided at an entire inner peripheral end of the gas blow-out prevention member; and a liquid return duct for returning the absorption liquid staying on the gas blow-out prevention member to the absorber tank is connected to the gas blow-out prevention member.

6. A wet flue gas desulfurization device according to claim 3, wherein:
a mounting lug is fixed to the sidewall of the absorber so as to extend along the circumferential direction of the inner surface of the sidewall of the absorber; and the gas blow-out prevention member is mounted on the lug so as to be fixed not to the sidewall of the absorber but to the lug.

7. A wet flue gas desulfurization device according to claim 4, wherein:
a mounting lug is fixed to the sidewall of the absorber so as to extend along the circumferential direction of the inner surface of the sidewall of the absorber; and the gas blow-out prevention member is mounted on the lug so as to be fixed not to the sidewall of the absorber but to the lug.

8. A wet flue gas desulfurization device according to claim 5, wherein:
a mounting lug is fixed to the sidewall of the absorber so as to extend along the circumferential direction of the inner surface of the sidewall of the absorber; and the gas blow-out prevention member is mounted on the lug so as to be fixed not to the sidewall of the absorber but to the lug.

9. A wet flue gas desulfurization device according to claim 1, wherein:
a mounting lug is fixed to the sidewall of the absorption tower so as to extend along the circumferential direction of the inner surface of the sidewall of the absorption tower; and the gas blow-out prevention member is mounted on the lug so as to be fixed not to the sidewall of the absorption tower but to the lug.
